(19) United States
(12) Patent Application Publication
(10) Pub. No.: US 2011/0099073 A1
(43) Pub. Date: Apr. 28, 2011

(54) Systems and methods for electronic transaction management

(76) Inventor: Tamer Yigit, Sydney (AU)

(21) Appl. No.: 12/606,208

(22) Filed: Oct. 27, 2009

(51) Int. Cl. G06Q 30/00; G06Q 10/00; G06F 17/30

(52) U.S. Cl. 705/14.66; 705/30; 707/609; 707/E17.005; 707/758; 707/E17.107

(57) ABSTRACT

Described herein are systems and methods for managing transaction records. In overview, consumers are issued respective tokens, which are presented to a supplier at the time an item is purchased. Rather than, or in addition to, issuing a paper receipt, the point of sale (POS) equipment scans the card and extracts an identifier. The point of sale equipment then formats an electronic receipt and sends the receipt to a predetermined location based on the extracted identifier.

### FIELD OF THE INVENTION

The present invention relates to systems and methods for electronic transaction management.

Embodiments of the invention have been particularly developed for providing an electronic receipt. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

When a consumer purchases an item from a supplier, it is the consumer's expectation that a proof of purchase, in the form of a receipt, is issued at the point of sale by the supplier. Paper receipts are typically on small slips of thermal paper which are printed directly at the point of sale.

Paper receipts suffer from an inherent problem in the sense that they are often lost, damaged, or otherwise unavailable at a later date. By way of example, receipts printed on thermal paper, extended exposure to UV light may also cause the printed information to fade, thereby losing the information printed thereon.

Loss or damage to paper receipts is problematic in a number of situations. For example:

In terms of warranty claims and the like. As is well known in the art, the purchase price of an item tends to include after sales service, such as a time-limited warranty to protect the consumer from loss in the event the item is faulty or malfunctions within a limited time. For smaller items, such as electronic consumer goods, the warranty is generally around twelve to twenty four months. However, especially for larger ticket items, the warranty may be much longer than this. If a consumer wishes to claim warranty for their item, the typical procedure is to contact the manufacturer and/or the supplier, return the item in questions and present the proof of purchase. Unfortunately, especially after extended lengths of time, the receipt is prone to being lost.
In terms of taxation. Paper receipts are often required for the taxation purpose, be it in relation to the lodgement of a personal or business tax return, in relation to an audit, or in circumstances where refunds are sought for local taxes at a national or state border.

Many other similar situations also exist.

For particularly well-organised consumers, a partial solution is to keep a copy of the receipt on file. Another partial solution is the electronic receipt. In recent times, with the advent of ecommerce, electronic receipts are becoming more common.

However, the copy of the receipt is still prone to loss. Additionally, it is only practical to issue electronic receipts when the whole transaction is conducted electronically—consumers who purchase items from a supplier in person do not have this option.

### SUMMARY OF THE INVENTION

It is an object of the present invention to overcome or ameliorate at least one of the disadvantages of the prior art, or to provide a useful alternative.

One embodiment provides a method for providing data to a consumer, the method including:

receiving data indicative of a transaction between a consumer and a retailer, wherein the data includes a consumer identifier indicative of the consumer, data for defining an electronic receipt in respect of the transaction, and data indicative of one or more characteristics of the transaction;

defining an electronic receipt for the transaction;

associating the electronic receipt with the consumer identifier in a database;

based on the data indicative of one or more characteristics of the transaction, updating profiling information associated with the consumer identifier in a database;

providing a web-based interface for allowing the consumer to access one or more electronic receipts associated with the consumer identifier for that consumer;

providing, via the web-based interface, data indicative of the one or more electronic receipts associated with the consumer identifier for that consumer; and

providing, via the web-based interface, in association with the data indicative of the one or more electronic receipts, data indicative of one or more advertisements, wherein the one or more advertisements are selected from a repository of potential advertisements on the basis of the profiling information associated with the consumer identifier.

According to one aspect of the invention, there is provided a method for managing transaction records, the method including the steps of:
(a) generating data indicative of a transaction record of a transaction between a supplier and a consumer;
(b) defining, on the basis of the data indicative of a transaction record, an electronic receipt;
(c) extracting data indicative of an identifier carried by a token, the identifier corresponding to a predetermined location that is configured to accept electronic receipts for the consumer; and
(d) sending the electronic receipt to the predetermined location.

In one embodiment, the above method further includes the steps of:
(e) receiving the electronic receipt at the predetermined location;
(f) storing the electronic receipt; and
(g) selectively retrieving the stored electronic receipt by the consumer.

Preferably, the data indicative of a transaction record is generated at the point of sale when the consumer purchases an item from the supplier.

Preferably, the electronic receipt is the consumer's proof of purchase of the item. The electronic receipt is preferably formatted in dependence upon the identifier information and includes one more of following formats: an email, an SMS message, a printout of the electronic receipt or a database record. Preferably, the electronic receipts are assigned a category and are respectively stored in accordance with the assigned category.

The identifier preferably includes the consumer's contact information. Preferably, the contact information includes one or more of: an email address, a telephone number, a physical address or an electronic database. The electronic database is preferably accessible remotely using an online interface.

Preferably, the token includes a memory and the predetermined location includes that memory.

Preferably, the step of extracting data indicative of an identifier is performed by point of sales equipment located at a site of the supplier.

A computer readable medium carrying a set of instructions that, when executed by one or more processors, cause the one or more processors to perform a method described in the paragraphs above.

According to another aspect of the invention, there is provided a method of managing transaction records, including the steps of:
(a) providing a token for carrying data indicative of an identifier; the identifier corresponding to a predetermined location that is configured to accept electronic receipts for the consumer;
(b) generating an electronic receipt on the basis of a transaction record of a transaction between a supplier and a consumer;
(c) extracting the identifier from the token;
(d) formatting the electronic receipt based on the identifier;
(e) forwarding the electronic receipt to the predetermined location;
(f) receiving and storing the electronic receipt at the predetermined location.

According to another aspect of the invention, there is provided a transaction management system for managing transaction records, the system including:
(a) point of sale equipment for generating data indicative of a transaction record of a transaction between a supplier and a consumer, wherein the data indicative of a transaction record defines an electronic receipt;
(b) a token reader for extracting data indicative of an identifier carried by a token, the identifier corresponding to a predetermined location that is configured to accept electronic receipts for the consumer; and
(c) a communication interface for sending the electronic receipt to the predetermined location.
(d) A system according to claim 14 further including:
(e) a communication interface for receiving the electronic receipt at the predetermined location;
(f) memory for storing the electronic receipt at the predetermined location; and
(g) an interface for selectively retrieving the electronic receipt by the consumer.

According to another aspect of the invention, there is provided a transaction management system for managing transaction records, the system including:
(a) a token for carrying data indicative of an identifier; the identifier corresponding to a predetermined location that is configured to accept electronic receipts for the consumer;
(b) a token reader for extracting the identifier from the token;
(c) point of sale equipment for generating an electronic receipt on the basis of a transaction record of a transaction between a supplier and a consumer and for formatting the electronic receipt based on the identifier;
(d) a communication interface for forwarding the electronic receipt to the predetermined location;
(e) a communication interface for receiving the electronic receipt at the predetermined location;
(f) memory for storing the electronic receipt; and
(g) an interface for selectively retrieving the electronic receipt by the consumer.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a flow diagram representation of a method according to one embodiment.

FIG. 2 is a flow diagram representation of a method according to one embodiment.

FIG. 3 is a flow diagram representation of a method according to one embodiment.

FIG. 4 is a schematic representation of a system according to one embodiment.

FIG. 5 is a schematic representation of a system according to one embodiment.

FIG. 5 is a schematic representation of a smart card according to one embodiment.

### DETAILED DESCRIPTION

Described herein are systems and methods for managing transaction records. In overview, consumers are issued respective tokens, which are presented to a supplier at the time an item is purchased. Rather than, or in addition to, issuing a paper receipt, point of sale (POS) equipment extracts an identifier associated with the token. The point of sale equipment then defines data indicative of an electronic receipt and sends that data receipt to a predetermined location based on the extracted identifier.

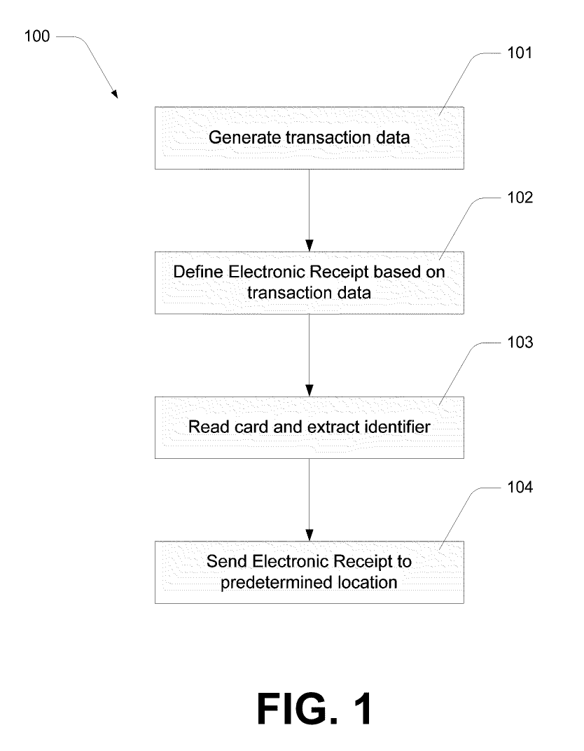

FIG. 1 illustrates an embodiment of the invention, in the form of a method 100 for managing transaction records. The transaction records are generated at the point of sale. When a consumer purchases an item from a suppler, POS equipment generates and stores a record of that sale. These records are necessary for many reasons, such as proof of purchase, internal bookkeeping and for providing after sales service.

At step 101, the POS equipment generates data indicative of a transaction record for a transaction between a supplier and a consumer, once a purchase or other transaction has been made. At step 102, an electronic receipt is defined on the basis of the data indicative of a transaction record. In an embodiment, rather than defining an electronic receipt, the data indicative of a transaction record further includes a date from which an electronic receipt is later generated. The generation of transaction data is generally known in the art and, as mentioned above, is presently being used to generate a paper-based receipt that is handed to the consumer on the spot.

As shown at step 103, data indicative of an identifier that is carried by a token is extracted. In one embodiment, the identifier is an email address that is embedded in a smart card, and it corresponds to a predetermined location (essentially the consumer's email inbox). The consumer's email inbox is configured to receive the electronic receipt. Finally, at step 104, the electronic receipt is sent to the consumer's inbox.

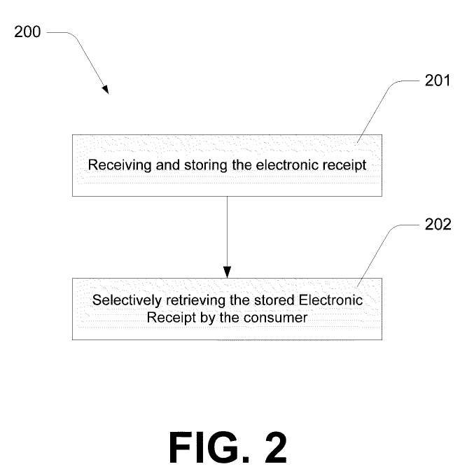

In further or additional embodiments, the method also includes further processing, as shown in FIG. 2. These include step 201, receiving and storing the electronic receipt at the consumer's inbox and step 202, selectively retrieving the stored electronic receipt by the consumer. These steps effectively allow the consumer to readily access they electronic receipts at any time in the future when the proof of purchase information may be necessary, such as when attempting to claim warranty repairs several years down the track.

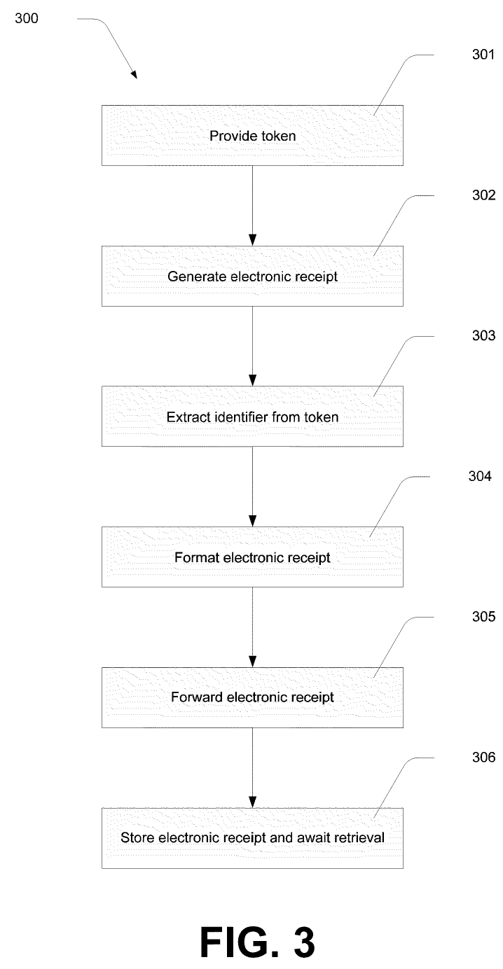

Another embodiment of the invention, method 300, is illustrated in FIG. 3.

At step 301, a token is provided to the consumer for carrying data indicative of an identifier. The identifier corresponds to a predetermined location that is configured to accept electronic receipts for the consumer.

At step 302, an electronic receipt is generated on the basis of a transaction record of a transaction between a supplier and a consumer. At step 303, the identifier is extracted from the token. At step 304, the electronic receipt is formatted, based on the identifier. At step 305, the electronic receipt is forwarded to the predetermined location. At step 306, the electronic receipt is stored at the predetermined location, awaiting retrieval.

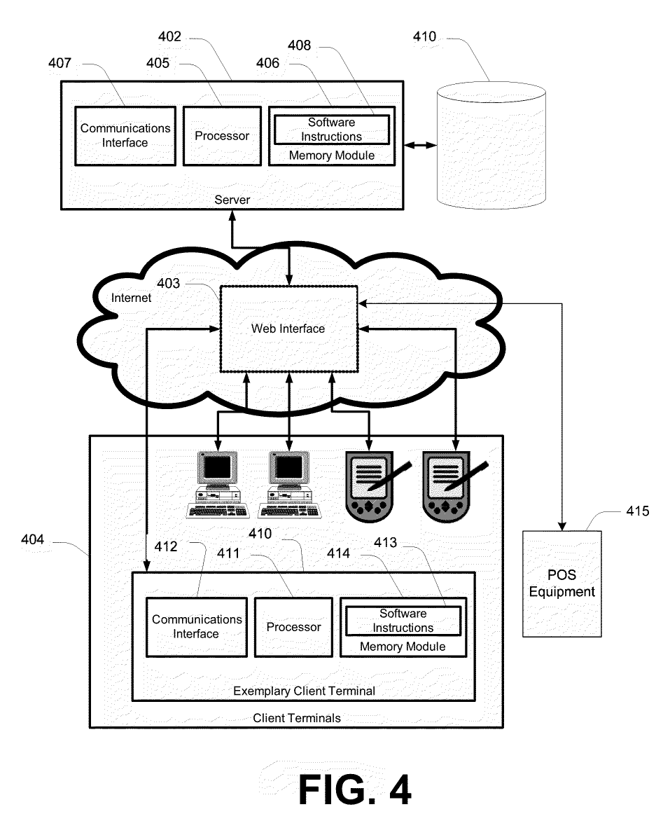

It will be appreciated by those skilled in the art that the identifier can take many different forms other than an email address. For example in the embodiment illustrated in FIG. 4, the identifier contains location information of a web server 402, which provides an online interface 403. This interface is accessed by the consumer by way of client terminals 404, which in various embodiments include the likes of personal computers, PDAs, cellular telephones, gaming consoles and other Internet enabled devices. In addition to the FIG. 4 embodiment, or in another embodiment, the location information of the web server 402 is hidden. The web server 402 is accessed by a consumer using an user ID, which is configured to interact with and unlock location information stored in a remote control server (not shown).

POS equipment 415 is located at the supplier's site, and is accessed at the point of sale when a consumer purchases an item. The POS equipment is shown in more detail in FIG. 4, and is described in more detail below.

Server 402 includes a processor 405 coupled to a memory module 406 and a communications interface 407, such as an Internet connections, modem, Ethernet port, wireless network card, serial port or the like. In other embodiments. Distributed resources are used. For example, in one embodiment, server 402 includes a plurality of distributed servers having respective storage, processing and communications resource. Memory module 406 includes software instructions 408, which are executable on processor 305.

Server 402 is coupled to a database 410, which in some embodiments includes a plurality of distributed storage locations. In further embodiments, the databases leverages memory module 406. Database 410 maintains data indicative of the electronic receipts.

In some embodiments, the online interface 403 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser applications download code, such as HTML code, from the server. This code is executable through the web-browser on the client terminal for providing a graphical and often interactive representation of the website on the terminal. By way of the web-browser application, the consumer navigates between and throughout various web pages provides by the website, and accesses various functionalities that are provided.

Although some embodiments make use of a website/browser based implementation, in other embodiments, proprietary software methods are implemented as an alternative. For example, in such embodiments, client terminals 404 maintain software instructions for a computer program product that essentially provides access to a portal via which electronic receipts are accessed.

In general terms, each terminal 404 includes a processor 411 coupled to a memory module 413 and a communications interface 412, such as an internet connection, modem, Ethernet port, serial port or the like. Memory module 413 includes software instructions 414 which are executable on processor 411. These software instructions allow terminal 404 to execute a software application, such as a proprietary application or web browser application and thereby render on-screen a user interface and allow communication with the server 402. This user interface allows for the retrieval of electronic receipt data.

In additional or other embodiments, further processing is conducted by the server 402 once the electronic receipt is received. In this embodiment, data maintained by database 410 is electronically assigned a category, depending upon the type of expense that the electronic receipt is related to. For example, one of the electronic receipts is categorised as “personal” while another of the electronic receipts is categorised as “business”. In this way, any required electronic receipt is readily accessible when needed, for example, at tax time. All the electronic receipts categorised as “business” are called up and deducted accordingly on the consumer's taxable income.

For example, in one embodiment, the token is in the form of a card having dual magnetic strips—the first strip designated for business expenses and the second strip designated for personal expenses. In a hypothetical shopping trip, a consumer wishes to purchase a set of overalls for work use in addition to a pair of jeans for personal use. For the overalls, at the time of purchase, the consumer will allow the first strip to be read, while for the jeans, the consumer will allow the second strip to be scanned. In this way, records of deductible work expenses are automatically categorised.

It will be appreciated that this embodiment is not limited to the use of dual magnetic strips. Other methods, such as dual barcodes, or embedding dual identifier information onto an integrated circuit chip, will readily presented themselves to those skilled in the art.

It will be appreciated that the above categorisations are used for exemplary purposes only, and that there is no limit on the number, or name, of the actual category. Further, it should be noted that where the categorisation takes place is not important. Therefore, in a further embodiment, categorisation takes place at the point of sale, when the electronic receipt is generated, but before it is sent.

In an additional or alternative embodiment, the further processing conducted by the web server 402 gathers and interpolates the transaction data for other applications, such as for use in directed marketing campaigns. The information is also adaptable for other uses, such as in demographic studies.

In other embodiments, the identifier is a mobile or cellular telephone number, and the electronic receipt is formatted for transmission via SMS. Those skilled in the art will appreciate that other electronic means of transmission are equally adaptable for the present system.

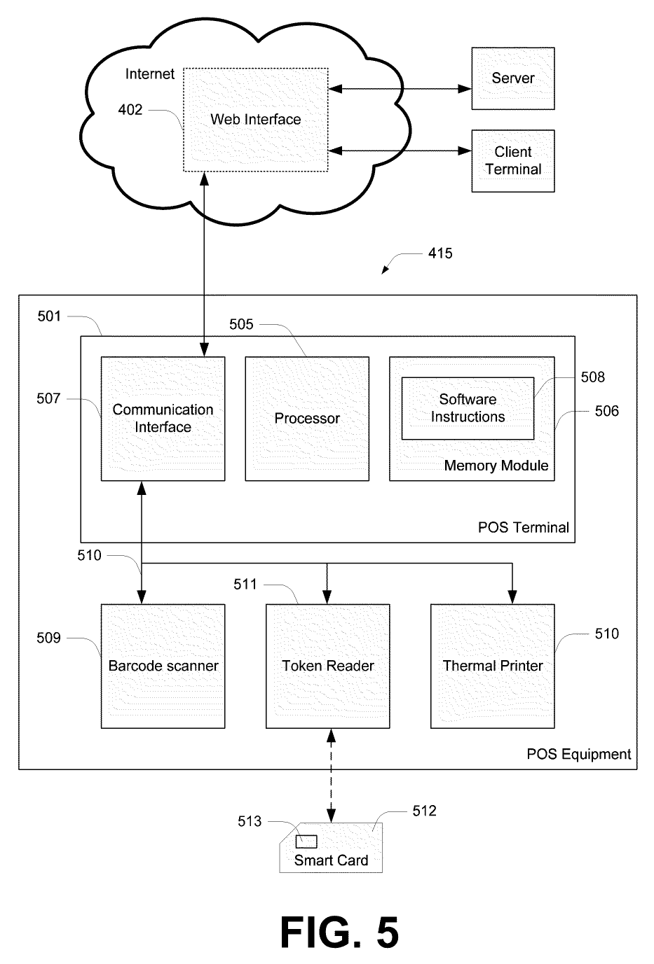

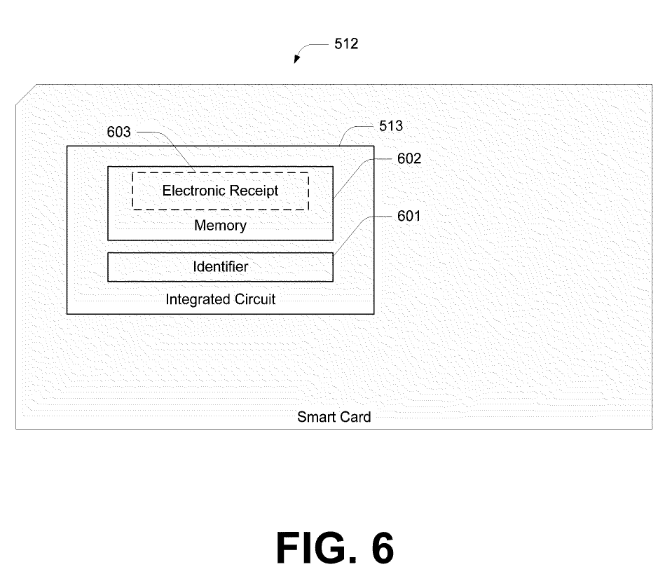

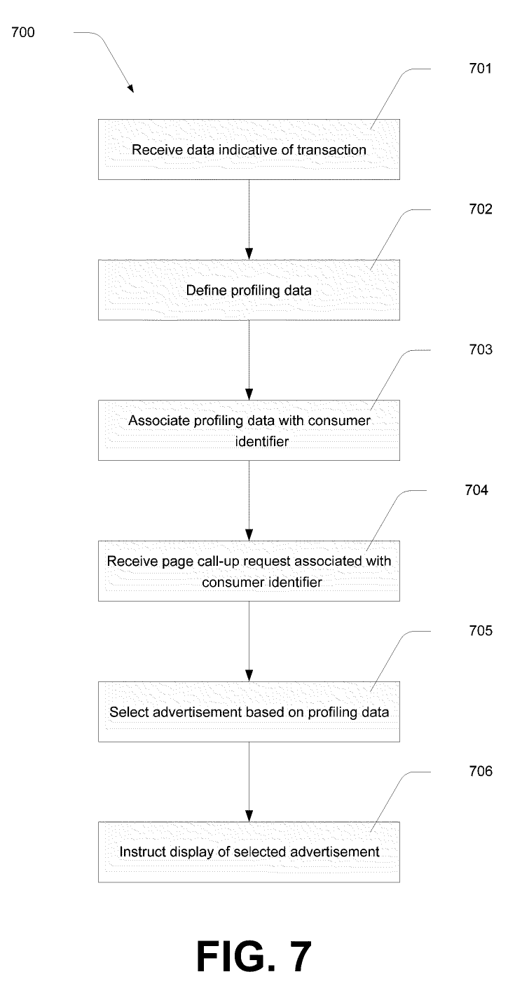

FIG. 5 shows an embodiment of the POS equipment 415. POS Equipment includes a POS terminal 501, which is coupled with a barcode scanner 509, a token reader 511 and a thermal printer 510.

POS terminal 501 includes a processor 505 coupled to a memory module 406. A communications interface 407 is also included for providing a serial connection. In some embodiments, the communications interface 507 also provides an Internet connection, a LAN/WAN connection or the like. Memory module 506 includes software instructions 508, which are executable on processor 505.

As shown in FIG. 5, barcode scanner 509 is connected to the POS terminal 501 via a serial connection 510. As is known in the art, the barcode scanner is used at the point of sale to scan the barcode of the item being purchased. When the transaction is conducted, the POS terminal 501 generates data indicative of the transaction record of the transaction between the supplier and the consumer. The data indicative of a transaction record is used to define a receipt, which is printed out from thermal printer 510.

In addition to or in place of generating a printed receipt, the POS terminal 501 uses the data indicative of a transaction record to define an electronic receipt.

A token reader 511 is provided to extract data indicative of an identifier carried by a token, which, in the form of a smart card 512, is discussed in greater detail below. As noted above, the identifier corresponds to a predetermined location that is configured to accept electronic receipts for the consumer. The communication interface 507 is also configured for sending the electronic receipt to the predetermined location.

Continuing with the example where the identifier is indicative of an email address, the POS terminal 501 formats the electronic receipt into a format suitable for sending via email. The communications interface 507 then sends the email, containing the electronic receipt for example as an attachment, to the consumer's email inbox.

It will be appreciated that various embodiments provide arrangements for a user to view data indicative of their respective transactions (such as receipts) in an online environment. In some cases this is achieved email (optionally provided via a webmail interface such as Gmail or the like), and in other cases it is achieved via a website service that provides a user interface for displaying data maintained in a central database (i.e. a consumer logs on to a website using identification data, and is subsequently able to view receipt data and the like via that website). Some embodiments of the present invention are directed to the provision of directed marketing material via such an online environment. One such embodiment takes the form of the following computer implemented method, described by reference to method 700 of FIG. 7.

Step 701 includes receiving data indicative of a transaction. For example, in one embodiment this includes receiving data indicative of a transaction between a consumer and a retailer, wherein the data includes
A consumer identifier indicative of the consumer (which may be extracted from a consumer's token).
Data for defining an electronic receipt in respect of the transaction, generally as described above. The electronic receipt with is associated with the consumer identifier in a database, generally as described above.
Data indicative of one or more characteristics of the transaction.

The data for defining the electronic receipt and the data indicative of one or more characteristics of the transaction may wholly or partially overlap. For example, the data indicative of one or more characteristics used for defining profile information may simply be extracted from the same data that is used for defining the electronic receipt. However, in other embodiments the data indicative of one or more characteristics includes alternate and/or additional data. For example, in one embodiment additional data is defined describing characteristics of goods and/or services purchased in the transaction (for example in terms of brand, price, industry, and so on). This data is used for the purposes of defining profiling data at step 702, and associated with the relevant consumer at step 703. For example, based on the data indicative of one or more characteristics of the transaction, a process is performed thereby to update profiling information associated with the consumer identifier in a database. In this manner, each consumer is associated with profiling information.

The profiling information is used for the purposes of directing specifically selected advertising material to each consumer. The manner in which this occurs depends on the nature of profiling information collected. One approach is to define a plurality of profiling criteria, and assign the consumer values for each criterion. Examples of criteria include:
Locality criteria. For example, this may include areas where the consumer lives, such as in terms of state and locality, or where has purchased goods and/or services, such as in terms of regions or shopping malls.
Product interest criteria. For example, this may be defined in terms of the types of products purchased during a predefined timeframe. One example is that a consumer may receive a value for having purchased a bicycle, creating a bias to advertise bicycle related goods and/or services.
Brand selection criteria (for example in terms of brands to which purchased goods/services are attributable).

It will be appreciated that the above are examples only, and there is a wide range of criteria that may be defined for a particular application. The criteria values are then used for the purpose of matching advertising material to a consumer, as is common generally in the field of direct marketing. The key here is a nexus between information collected in relation to a particular consumer's spending habits (collected through the present electronic receipt maintenance arrangement) and the provision of directed marketing material based on that information via a system configured to provide electronic receipts.

In terms of method 700, a web-based interface is provided for allowing the consumer to access one or more electronic receipts associated with the consumer identifier for that consumer. The consumer interacts with that web-based interface (for example using a web browser), resulting in the generation of page call-up requests. In response to appropriately defined call-up requests interface provides data indicative of the one or more electronic receipts associated with the consumer identifier for that consumer. A call-up requests are received at step 704 processed at step 705 thereby to select advertisements based on the profiling data, such that relevant advertising material is able to be displayed on a page transmitted for rendering by the consumer's client terminal in respect of a call-up request. Instructions in this regard are provided at step 706. In this manner, the method includes providing, via the web-based interface, in association with the data indicative of the one or more electronic receipts, data indicative of one or more advertisements, wherein the one or more advertisements are selected from a repository of potential advertisements on the basis of the profiling information associated with the consumer identifier.

In some embodiments, alternate means of communication are used in addition to email (or, in some cases, as an alternative). Where there is a desire to provide an electronic receipt to a mobile or cellular telephone number (for instance via short message service) the formatting of receipt is necessarily different as compared with email. It will be appreciated that the format of the electronic receipt will suggest itself to those skilled in the art, depending on the method of electronic transmission. It will be appreciated that electronic provision of the electronic receipt to a centralised location (such as an email address) possesses substantive advantages over discrete locations (such as cellular phones). For that reason, if the latter are used, that typically occurs in addition to the use of a centralised location.

In one embodiment, the token is a smart card 512, which is illustrated in greater detail in FIG. 6. The smart card is a pocket-sized card suitable for carrying, for example in a wallet. The smart card includes an integrated circuit 513, which is configured to store the identifier 601 that is readable by the token reader 511.

In one embodiment, the integrated circuit 513 includes a memory 602 that is configured to store the electronic receipt. In such an embodiment, the electronic receipt 603, once it is correctly formatted, is stored directly on the card 512. However, such an approach is ideally used in combination with the provision of the electronic receipt to by email.

It will be appreciated that there are many ways for storing information such as an identifier on pocket-sized cards, including, but not limited to, using a magnetic stripe or using a printed barcode. Other alternatives will readily present themselves to the person skilled in the art. In the case of the printed barcode, in one embodiment, the token reader 411 is integrated with the barcode reader 409.

It will also be appreciated that the token may be implemented other than by a card.

For example, in one embodiment, the token is an electronic device configured to communicate with the POS equipment wirelessly. Wireless communication technologies are generally known to those skilled in the art and, in embodiments, include Bluetooth, WiFi, RFID, infra red and the like. In further embodiments, the token is implemented by other than a device. Examples of this will also be known to those skilled in the art and, in embodiments, take advantage of the user's biometric information, such as the user's facial impressions, thumb or finger prints, voice characteristics or the like.

In other embodiments, the identifier is incorporated in other tokens, which the consumer may already make use of. Examples of these include credit cards, debit cards, loyalty cards such as “flybuys”, membership cards, identification cards and the like. Other examples include key rings, keys, or electronic devices such as mobile or cellular telephones, pagers, PDAs and the like.

In further embodiments, the token is simply programmed into the system. POS equipment is connected to web server 402 in such a way that a password is entered into the POS terminal 501. Once a user has been verified in this manner, the electronic receipt is sent to the web server 402 in such a way so as to allow subsequent access to the electronic receipt to the verified consumer.

It will be appreciated that the spirit of the invention may be accomplished in many ways that will be apparent to those skilled in the art. In particular, it should be noted that the term “token” as used herein includes both physical and virtual tokens. Examples of various implementations are given above, but to reiterate, physical tokens in various embodiments are implemented as cards or devices, virtual tokens in various embodiments are implemented using a user's voice characteristics or through the use of a password. Among various embodiments, tokens can include substantially any form of personalising information that a consumer is able to furnish at the point of sale. Such information may be carried by a carrier substrate/medium, or inferred from observation of an event or article.

It will be appreciated that the disclosure above provides various systems and methods for managing transaction records. Electronic receipts, which are defined based on the transaction record, are stored at a predetermined location electronically. The electronic receipts remain stored at the predetermined location indefinitely, and are not prone to being lost. The data on the electronic receipt also has more integrity as the electronic receipt is not susceptible to fading over time, as with thermally printed paper receipts.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for providing data to a consumer, the method including:
a. receiving data indicative of a transaction between a consumer and a retailer, wherein the data includes a consumer identifier indicative of the consumer, data for defining an electronic receipt in respect of the transaction, and data indicative of one or more characteristics of the transaction;
b. defining an electronic receipt for the transaction;
c. associating the electronic receipt with the consumer identifier in a database;
d. based on the data indicative of one or more characteristics of the transaction, updating profiling information associated with the consumer identifier in a database;
e. providing a web-based interface for allowing the consumer to access one or more electronic receipts associated with the consumer identifier for that consumer;
f. providing, via the web-based interface, data indicative of the one or more electronic receipts associated with the consumer identifier for that consumer; and
g. providing, via the web-based interface, in association with the data indicative of the one or more electronic receipts, data indicative of one or more advertisements, wherein the one or more advertisements are selected from a repository of potential advertisements on the basis of the profiling information associated with the consumer identifier.

2. A method for managing transaction records, the method including the steps of:
a. generating data indicative of a transaction record of a transaction between a supplier and a consumer;
b. defining, on the basis of the data indicative of a transaction record, an electronic receipt;
c. extracting data indicative of an identifier carried by a token, the identifier corresponding to a predetermined location that is configured to accept electronic receipts for the consumer; and
d. sending the electronic receipt to the predetermined location.

3. A method according to claim 2 further including the steps of delivering to the consumer directed marketing information responsive to the data indicative of the transaction record.

4. A method according to claim 2 further including the steps of:
a. receiving the electronic receipt at the predetermined location;
b. storing the electronic receipt; and
c. selectively retrieving the stored electronic receipt by the consumer.

5. A method according to claim 2 wherein the data indicative of a transaction record is generated at the point of sale when the consumer purchases an item from the supplier.

6. A method according to claim 5 wherein the electronic receipt is the consumer's proof of purchase of the item.

7. A method according to claim 2 wherein the identifier includes the consumer's contact information.

8. A method according to claim 7 wherein the contact information includes one or more of: an email address, a telephone number, a physical address or an electronic database.

9. A method according to claim 6 wherein the electronic database is accessible remotely using an online interface.

10. A method according to claim 8 wherein the electronic receipt is formatted in dependence upon the identifier information and includes one more of following formats: an email, an SMS message, a printout of the electronic receipt or a database record.

11. A method according to claim 2 wherein the token includes a memory and the predetermined location includes that memory.

12. A method according to claim 2 wherein the step of extracting data indicative of an identifier is performed by point of sales equipment located at a site of the supplier.

13. A method according to claim 2 wherein the electronic receipts are assigned a category and are respectively stored in accordance with the assigned category.

14. A method of managing transaction records, including the steps of:
a. providing a token for carrying data indicative of an identifier; the identifier corresponding to a predetermined location that is configured to accept electronic receipts for the consumer;
b. generating an electronic receipt on the basis of a transaction record of a transaction between a supplier and a consumer;
c. extracting the identifier from the token;
d. formatting the electronic receipt based on the identifier;
e. forwarding the electronic receipt to the predetermined location;
f. receiving and storing the electronic receipt at the predetermined location.
